(19) United States
(12) Patent Application Publication
(10) Pub. No.: US 2010/0065368 A1
(43) Pub. Date: Mar. 18, 2010

(54) LIGHTWEIGHT, FLEXIBLE, MOLDABLE ACOUSTIC BARRIER AND COMPOSITES INCLUDING THE SAME

(76) Inventor: Vatche Tazian, Beverly Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/560,255

(22) Filed: Sep. 15, 2009

Related U.S. Application Data
(60) Provisional application No. 61/192,066, filed on Sep. 15, 2008.

(51) Int. Cl. E04B 1/84; B29C 47/02

(52) U.S. Cl. 181/290; 264/241; 181/294

(57) ABSTRACT

A composite, light weight flexible, moldable composite acoustic barrier and method of making the same.

### CROSS-REFERENCE TO RELATED APPLICATIONS

This Application claims the benefit of U.S. Provisional Application 61/192,066 filed on Sep. 15, 2008.

### TECHNICAL FIELD

In one aspect, the present disclosure is related to a lightweight, flexible, foam acoustic barrier for use with automotive, industrial and home appliance applications.

In another aspect, the present disclosure relates to a lightweight, flexible, moldable fine celled cross linked thermoplastic foam that may be applied to automotive trim and insulation components to serve as a noise reduction barrier.

In another aspect, the present disclosure relates to a composite construction of a lightweight, flexible, moldable, fine celled, cross linked thermoplastic foam that is comprised of a mixture of polyolefin resins, foaming agents and processing aids that may be subjected to heat, ultraviolet radiation (UV), or electron irradiation to initiate foaming and cross linking of the foam material. Additional layers in a composite may be used with the foam to improve sound deadening properties. The additional material may include a thermoset plastic including ethylene vinyl acetate (EVA) copolymer, high density polyethylene, low density polyethylene, linear low density polyethylene, polypropylene, thermoplastic elastomer/rubber, polyvinyl chloride (PVC) or any combination of the foregoing.

The present disclosure further relates to a lightweight, moldable, fine celled, cross linked thermoplastic foam that is applied to, for example, automotive carpeting, trim, dash and door panel applications and subjected to molding under suitable conditions for a sufficient period of time to form a three dimensional composite construction with improved acoustic barrier properties.

### BACKGROUND OF THE INVENTION

Acoustic barriers have long been used in automotive, home appliance and industrial product applications. There has been a tradeoff between weight, thickness of the acoustical barrier and the appearance, and efficacy of the sound reduction barrier.

In automotive applications, such a trade off has occurred where the weight of the sound deadening barrier has had a direct effect on the efficacy of sound deadening barrier, as well as to the overall weight of the vehicle. Increasingly, especially with rising fuel costs, it has become an imperative from all Original Equipment Manufacturers (OEM's) to reduce the overall weight of the vehicle, while retaining or increasing the effectiveness of sound deadening properties of the insulating layer. In addition, with rising labor and material costs, there is an increased pressure from the OEM's to find a solution that is lightweight, moldable, labor saving and exhibits increased sound deadening properties.

These and other properties will become apparent to those skilled in the art upon a reading of the application and the appended claims.

### BRIEF SUMMARY

The present disclosure is directed to a flexible, low cost, low weight, moldable fine celled thermoplastic cross linked foam that is applicable to trim and insulation components and acts as a noise reduction barrier in automotive, home appliance, and industrial product applications.

The thermoplastic foam is fine celled foam that is a mixture of polyolefin resins, foaming agents and processing aids that is subjected to electron irradiation to initiate the foaming and cross linking characteristic of the material. The foam may be combined with additional layers, such as a layer of EVA copolymer, high density polyethylene, low density polyethylene, linear low density polyethylene, polypropylene, thermoplastic elastomer/rubber, PVC or any combination thereof.

The foam component may be contacted with a heated polyethylene carpeting layer that acts as an adhesive to the foam or foam composite to the carpeting. The heated carpeting, with the foam adhesively attached, may be subjected to a mold under suitable conditions for a sufficient period of time and temperature and pressure to assume a three dimensional profile or configuration, such as, for example, an automotive floor plan. The molded composite is then cooled, trimmed, and may be placed into an automobile for which it was molded and impart improved sound deadening properties in a lightweight construction with a minimum amount of labor content. The sound deadening properties of such a composite are superior to existing woven and on-woven fibrous sound deadening layers, and equivalent to mass-backed layers (EVA). In addition, replacing existing (EVA) sound deadening barriers with the sound deadening composite of the present disclosure offers a 10 lb weight savings on a typical automotive carpet.

### BRIEF DESCRIPTION OF THE DRAWINGS

FIG. 1 is a schematic side view of a composite showing the multiple layers of each part of the composite sound deadening construction

FIG. 2 is a schematic representation of a molding process showing one method to form the composite component of the present disclosure.

FIG. 3 is a schematic representation of another molding process showing another method to form the composite composition of the present disclosure.

FIG. 4 is a schematic representation of another molding process showing another method to form a three dimensional molded material formed of the sound deadening foam composition.

FIG. 5 is a graph representation of a dynamometer test result for sound deadening at the driver head at 35 mph.

FIG. 6 is a graph representation of a dynamometer test result for sound deadening at the right rear passenger head at 35 mph.

FIG. 7 is a graph representation of a dynamometer test result for sound deadening at the driver head at 55 mph.

FIG. 8 is a graph representation of a dynamometer test result for sound deadening at the right rear passenger head at 55 mph.

FIG. 9 is a graph representation of a dynamometer test result for sound deadening at the driver head at 75 mph.

FIG. 10 is a graph representation of a dynamometer test result for sound deadening at the right rear passenger head at 75 mph.

### DETAILED DESCRIPTION

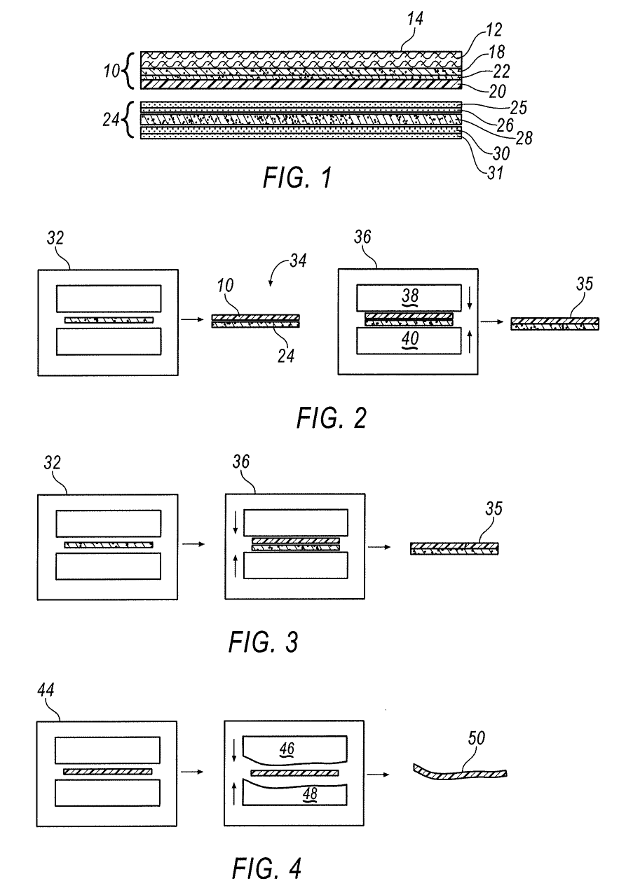

Turning now to the drawings where like numerals refer to like structures, FIG. 1 depicts a schematic representation of primary composite layer of material 10 having facing material 12 which may be automotive carpet, automotive body cloth, home appliance insulation or trim for an industrial application to present a face surface 14. The primary layer may also include optional intermediate layers 18 and 22, which may be padding materials usually employed by automotive or appliance or industrial applications to impart texture, as well as feel, pressure and give. The primary layer may further include a thermoset plastic layer 20 that may be comprised of ethylene vinyl acetate (EVA) copolymer, high density polyethylene, low density polyethylene, linear low density polyethylene, polypropylene, thermoplastic elastomer/rubber, polyvinylchloride (PVC), or any combination thereof. The thermoset plastic layer 20 may be of any suitable thickness and may further be of from about 0.08 to about 1.0 mm in thickness. The secondary layer 24 includes a thermoplastic moldable polyolefin foam component 28. The secondary layer may also include optional intermediate layer 25, which may be a scrim, and layers 26, 30 and 31 may be additional padding or sound deadening layers that may be affixed to the thermoplastic moldable foam layer of material 28.

The thermoplastic moldable polyolefin foam 28 may be a fine closed celled IR or UV irradiation cross linked foam that offers aesthetic appeal as well as improved performance characteristics. The foam is made from a variety of polyolefin resins and foaming agents. The thickness of the foam ranges from 0.01 inches to 0.42 inches, in roll form and from about 0.05 inches to about 2.00 inches in laminated rolled sheets. Preferably, the foam used is about 0.125 inches in thickness. The foam density is in the range of from about 1.6 to 6.6 pcf, and preferably the foam used has a density of about 4 pcf. Suitable foams that are commercially available include the product known as VOLARA® available from Sekisui America Corporation.

FIG. 2 schematically illustrates a method to form a component material according to one aspect of the disclosure. Heating element 32 applies heat, preferably hot air, contact heat or IR heat, to raise the temperature the primary layer thermoplastic material to a sufficiently tactile or state. Once the thermoplastic layer in the primary layer is of sufficient temperature, preferably from about 150° C. to about 250° C., the primary layer is moved to a station 34 where the sound deadening layer of foam material in the secondary layer is brought into engagement with the primary layer so that the two layers can be adhered together, The two layers are moved to a press 36 consisting of an upper press 38 and a lower press 40, and pressure is applied to cause the opposing presses to move together to force the primary and secondary layers together. The tactile or fluid thermoplastic layer of the primary layer adheres to the foam in the secondary layer and then is cooled to form an adhered bond between the two layers resulting in a completed assembly 35.

FIG. 3 depicts another method to form the improved, flexible lightweight fine celled cross linked thermoplastic foam components with improved sound deadening properties.

Specifically, the thermoplastic resin backed material, such as automotive carpeting may be heated as in FIG. 2, and moved directly to a mold as in FIG. 2 with the option that the mold may contain the thermoplastic cross linked foam already in place. The two component layers are brought into opposition with each other and the mold closed, cooled and the resulting product has a thermoplastic cross linked fine celled foam backing.

FIG. 4 is a schematic representation of one method to form a molded composite material with sound deadening properties as a three dimensional configuration or profile according to one aspect of the present disclosure.

Specifically, thermoplastic foam material is placed in a heating device as seen in FIG. 3, and heated, preferably through IR, contact or hot air to raise the temperature of the foam to its melting point. In this regard, it is preferred to raise the temperature in the range of about 150° C. to about 250° C. The foam is them moved to a die 44 with upper and lower forms 46 and 48, respectively, and closed and cooled, and the resultant composite form 50 has a three dimensional profile, such as, for example, an automotive floor plan or inner dash mat.

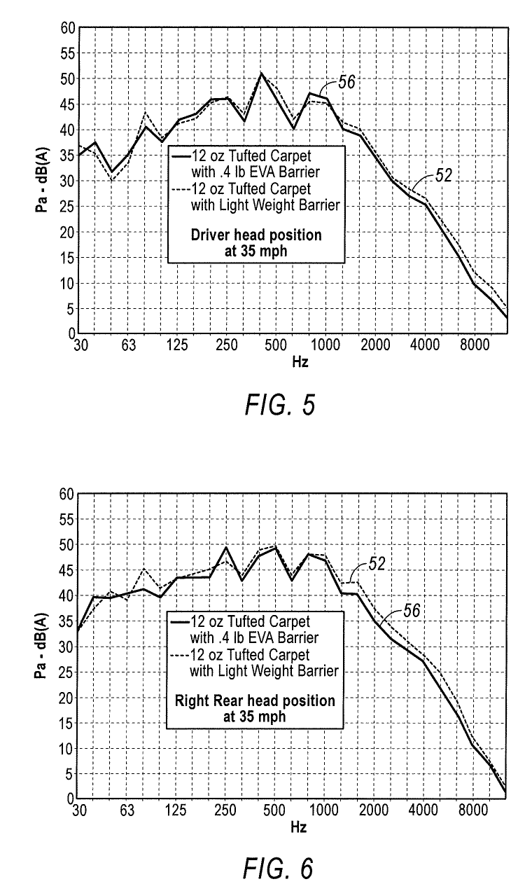

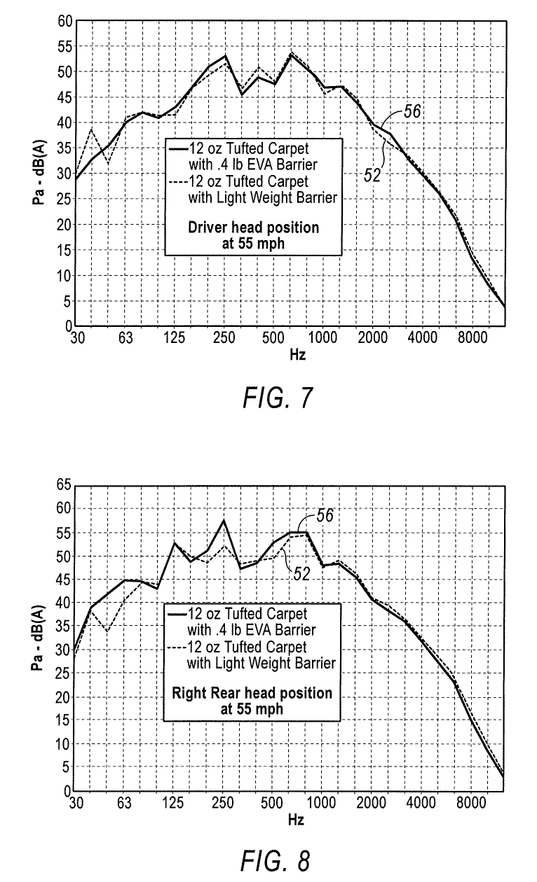

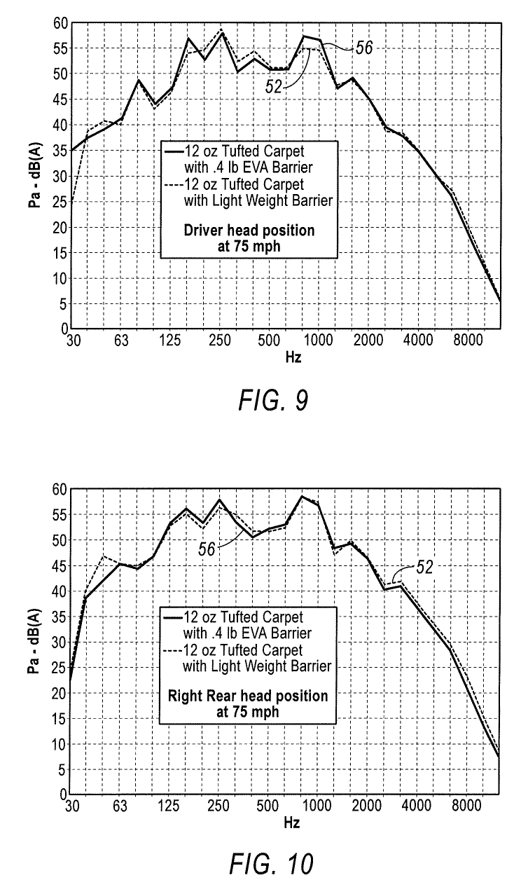

FIGS. 5 through 10 are graphs representing data from dynamometer tests at various speeds and positions in a test vehicle. FIGS. 5 and 6 are simulations of the noise levels perceived at driver head and right rear passenger head positions at 35 mph. FIGS. 7 and 8 are simulations of the noise levels perceived at driver head and right rear passenger head positions at 55 mph. FIGS. 9 and 10 are simulations of the noise levels perceived at driver head and right rear passenger head positions at 75 mph. In each of the FIGS, the x axis is given in Hertz, and the Y axis is given in Pascal-decibels. Thus, it can be seen that the graphs of FIGS. 5 through 10 are logarithmic. Moreover, in each graph for the FIGS. 5 through 10, line 52 represents the sound deadening data produced with 12 ounce tufted carpeting with 0.125 inches of fine celled cross linked thermoplastic foam. Line 56 represents the sound transmission of 12 ounce tufted carpeting with 0.41b EVA barrier. In each of the FIGS. 5 through 10, there was no significant difference in sound deadening properties between the foam backed carpet and the EVA backed carpet. It can be seen that through most of the data points, the foam backed carpet had lower or equivalent sound transmission loss than the EVA backed carpet.

In addition, the foam backed carpeting weighed significantly less than the EVA backed carpet sample, such that a vehicle may enjoy a weight savings of 10-15 lbs per vehicle or more.

The words used in the specification are words of description and not words of limitation. Those skilled in the art recognize that many variations and modifications may be possible without departing from the scope and spirit of the invention as set forth in the appended claims.

I claim:

1. A lightweight, flexible foam acoustic barrier, comprising:
a fine closed celled cross linked thermoplastic polyolefin foam having a thickness of from about 0.01 to about 2 inches, and a density of from about 1.6 to about 6.6 pcf.

2. The acoustic barrier of claim 1, further including at least one additional layer of a thermoset plastic including at least one of ethylene vinyl acetate, high density polyethylene, low density polyethylene, linear low density polyethylene, polypropylene, thermoplastic elastomer rubber, polyvinyl chloride, or combinations thereof.

3. The acoustic barrier of claim 1, further including a facing material adjacent to said thermoplastic foam.

4. The acoustic barrier of claim 1, further including a scrim material adjacent the thermoplastic foam.

5. The acoustic barrier of claim 1, wherein said thermoplastic foam is comprised of a mixture of polyolefin resins, foaming agents and processing aids that are cross linked to form the foam.

6. The acoustic layer of claim 4, wherein said facing material includes automotive carpet, automotive trim, automotive dashboard, automotive door panel material, automotive body cloth, insulation, and padding material.

7. A lightweight, flexible, moldable composite acoustic barrier, comprising:
a primary layer of a facing material and a thermoplastic polyolefin layer; and
a secondary layer of a fine celled cross linked thermoplastic foam having a thickness of from about 0.01 to about 2 inches, and a density of from about 1.6 to about 6.6 pcf.

8. The composite acoustic barrier of claim 7, further including at least one of padding materials and scrim interposed between said facing material and said thermoplastic layer.

9. The composite acoustic barrier of claim 7, wherein the thermoplastic layer may be at least one of ethylene vinyl acetate, high density polyethylene, low density polyethylene, linear low density polyethylene, polypropylene, thermoplastic elastomer rubber, polyvinyl chloride, or combinations thereof.

10. The composite acoustic barrier of claim 7, wherein said facing material is automotive carpet, automotive trim, automotive dashboard, automotive door panel material, automotive body cloth, insulation, or padding material.

11. A method to form a lightweight, flexible, moldable composite acoustic barrier, comprising:
heating a primary layer of the composite acoustic layer including a thermoplastic layer to a temperature sufficient to render the thermoplastic layer tactile;
bringing a secondary layer of acoustic polyolefin foam material into engagement with said primary layer of thermoplastic material; and
molding said first and second layers into engagement in a former die to form a three dimensional acoustic barrier.

12. The method of claim 11, wherein said primary layer further includes a facing material adhered on one side of said thermoplastic layer.

13. The method of claim 11, wherein said facing material includes automotive carpet, automotive trim, automotive dashboard or automotive door panel material; automotive body cloth, insulation, and padding material.

14. The method of claim 11, wherein said acoustic foam material is a fine closed celled cross linked thermoplastic foam having a thickness of from about 0.01 to about 2 inches, and a density of from about 1.6 to about 6.6 pcf.

15. The method of claim 11, wherein said thermoplastic layer is at least one of ethylene vinyl acetate, high density polyethylene, low density polyethylene, linear low density polyethylene, polypropylene, thermoplastic elastomer rubber, polyvinyl chloride, or combinations thereof.

16. The method of claim 11, wherein said heating is accomplished by application of hot air, contact heat or infrared heat.

17. The method of claim 11, wherein said dies is in the form of an automotive floor pan or firewall

18. The method of claim 11, wherein said temperature is in the range of from about 150° C. to about 250° C.
